(19) United States
(12) Patent Application Publication
(10) Pub. No.: US 2007/0237343 A1
(43) Pub. Date: Oct. 11, 2007

(54) Sound Enhancement

(75) Inventors: Daniel Willem Elisabeth Schobben, Eindhoven (NL); Ronaldus Maria Aarts, Eindhoven (NL); Okke Ouweltjes, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,576

(22) PCT Filed: Jul. 26, 2005
(86) PCT No.: PCT/IB05/52378

§ 371 Date: Jan. 24, 2007

(30) Foreign Application Priority Data
Jul. 26, 2004 (EP) 04103560.1

(51) Int. Cl. H04R 3/00

(52) U.S. Cl. 381/111

(57) ABSTRACT

A device (1) is arranged for adjusting the amplitude of an audio signal (x) such that the output of a transducer (2) coupled to the device is equivalent to the output of a reference transducer. The device comprises a first simulation unit (11) for producing a reference signal (y) in response to the audio signal (x), a second simulation unit (12) for producing a further signal (z) in response the audio signal (x), and comparator means (15) for comparing the reference signal (y) and the further signal (z) so as to produce an adjustment signal (a) which is fed to an adjustment unit (10). The first simulation unit (11) simulates the response of a reference transducer, while the second simulation unit (12) simulates the response of the actual transducer (2) to the audio signal (x).

The present invention relates to sound enhancement. More in particular, the present invention relates to enhancing an audio signal in accordance with the characteristics of the transducer used to produce the sound.

It is well known that different sound transducers may reproduce the same audio signal very differently. Most transducers, such as (electromagnetic or electrostatic) loudspeakers, are more efficient in one particular frequency band than in other frequency bands. An electrical input signal having a certain amplitude or energy will accordingly produce acoustic output signals having different amplitudes, in particular in certain frequency ranges. If the input signal has a limited frequency range, the output signal may strongly depend on the particular transducer used.

Recently transducers have been developed that are particularly efficient in a very narrow frequency band. Inside this frequency band, these transducers operate at or near their resonance frequency (or frequencies) and therefore require a relatively small (electrical) input signal to produce a large (acoustic) output signal. An example of such a transducer is described in European Patent Application no. EP 03103396.2 [PHNL031135]. Other examples include so-called “shakers” which are designed to make another object, such as a table top, resonate.

While such “resonant transducers” are much more efficient than regular transducers when operating at or near their resonance frequency, they are much less efficient at other frequencies. That is, at or near their resonance frequency (or frequencies) these resonant transducers produce a sound signal having a greater amplitude than would be produced by an ordinary transducer, while at other frequencies they produce a sound signal having a (much) smaller amplitude. The present inventors have realized that this discrepancy may lead to undesirable effects.

When a resonant transducer is designed to operate at 50 Hz, for example, and a particular song has much bass around 50 Hz, this bass will be rendered relatively loudly. When the next song has a similar amount of bass but is centered around 80 Hz, this bass will be barely audible when reproduced by the same transducer. It will be clear that this is undesirable, not only for bass reproduction, but also for the reproduction of other frequencies.

It is therefore an object of the present invention to overcome these and other problems of the Prior Art and to provide a device for and a method of adjusting the amplitude of an audio signal in accordance with the characteristics of a transducer.

Accordingly, the present invention provides a device for adjusting the amplitude of an audio signal in accordance with the characteristics of a transducer, the device comprising means for adjusting the amplitude of the audio signal such that the output power of the transducer is equivalent to the output power of a reference transducer. That is, the device of the present invention is arranged for producing, using a transducer having a certain characteristic, a sound signal that has an loudness (that is, perceived power) equivalent to the loudness of a sound signal that would have been produced using a reference transducer having a reference characteristic. This equivalent loudness is achieved by dynamically adjusting the sound level, also called “scaling”.

The term “equivalent loudness” as used here is meant to comprise both physically identical (or substantially identical) sound pressure levels, and perceptually identical (or substantially identical) sound pressure levels. It is well known that sound signals may be perceived to be identical even if they are physically (slightly) different.

In a preferred embodiment, the equivalent audio output adjustment means comprise:

first simulation means for producing, in response to the audio signal, a first signal indicative of the output of a reference transducer,

second simulation means for producing, in response to the audio signal, a second signal indicative of the output of the actual transducer,

comparator means for comparing the first signal and the second signal and for producing an adjustment signal, and

adjustment means for adjusting the amplitude of the audio signal in response to the adjustment signal.

The first simulation means produce a first signal that represents the output of a reference transducer when excited by the audio signal. This first signal, which represents the output of a “regular” transducer, is used as a reference signal. The second simulation means produce a second signal that represents the output of the actual transducer when excited by the same audio signal. This second signal, which represents the output of the actual (typically band-limited) transducer, is compared with the first (reference) signal to determine to which extent the output signals of the reference transducer and the actual transducer deviate. Typically, the reference transducer has a desired characteristic, for example a substantially flat output over a large frequency range.

The comparison of the first (reference) signal and the second (actual) signal produces an adjustment signal which is used to adjust the amplitude of the audio signal such that, within a certain frequency range or at a certain frequency, the audio signal is reproduced by the (actual) transducer at substantially the same sound level as if the audio signal were reproduced by the reference transducer.

The simulation means comprise a mathematical or hardware model of the transducers and may involve filters that simulate the signal response characteristics of the transducers, the filter parameters defining the model. These filters may be digital filters implemented in hardware and/or software. Some transducers may for example be suitable modeled by a high-pass filter.

The parameters may be determined in an experimental setting in which the output power of a reference transducer may be compared to the output power of a test transducer, both transducers receiving the same audio signal. The respective measured output power is used to determine model (filter) parameters.

It is noted that the present invention does not alter the frequency characteristics of the transducer. Instead, the amplification (or attenuation) of the audio signal is adjusted in accordance with the frequency characteristics.

In a particularly advantageous embodiment, the first simulation means and the second simulation means each comprise weighting means for perceptually weighting the audio signal. Such weighting means, which may carry out the well-known A-weighting procedure, adapt the audio signal to the human perception using a psycho-acoustic model. In this way, an adjustment may be achieved that is better adapted to the human ear.

In a preferred embodiment, the comparator means comprise first and second signal amplitude determination means for determining the amplitude of the first signal and the second signal respectively. The amplitude may be determined by calculating the RMS (Root Mean Square) value of the signal, which is a well-known measure of the energy content of a signal. It will be understood that, in this context, determining the signal amplitude and determining the signal energy are technically equivalent.

Advantageously, the comparator means may comprise amplitude ratio determination means for determining the ratio of the amplitudes of the first signal and the second signal and for producing the adjustment signal in accordance with said ratio. Alternatively, energy ratio determination means may be used if the energy of the signals is available. Such energy ratio determination means preferably utilize a maximum value (“ceiling”) to avoid incorrect results if the energy value in the denominator is very small.

In a preferred embodiment, the adjustment means comprise a controlled amplifier. This allows a simple audio signal level control. However, other adjustment means can also be used, such as voltage controlled resistors.

The present invention further provides an audio system comprising a device as defined above. The audio system of the present invention may further comprise a first filter unit for filtering the audio signal prior to being fed to the device, a second filter unit arranged in parallel to the first filter unit, and a combination unit for combining the output signals of the device and the second filter unit. The audio system, which may further comprise an amplifier and other components, suitable is a home cinema system or a car sound system. The audio system of the present invention may also be advantageously used in television sets.

The present invention additionally provides a method of adjusting the amplitude of an audio signal in accordance with the characteristics of a transducer, the method comprising the step of adjusting the amplitude of the audio signal such that the output power of the transducer is equivalent to the output power of a reference transducer.

In a preferred embodiment, the method of the present invention further comprises the steps of:

producing, in response to the audio signal, a reference signal indicative of the output of a reference transducer,

producing, in response to the audio signal, a further signal indicative of the output of the actual transducer,

comparing the reference signal and the further signal and producing an adjustment signal, and

adjusting the amplitude of the audio signal in response to the adjustment signal.

The reference signal and the further signal may be determined in accordance with transducer models, that is models simulating the characteristics of transducers. The method of the present invention may further comprise the step of perceptually weighting the audio signal, preferably using A-weighting.

The present invention also provides a computer program product for carrying out the method as defined above. The computer program product may comprise a carrier, such as a CD, DVD, or a floppy disc, on which a computer program is stored in electronic or optical form. The computer program specifies the method steps to be carried out by a general purpose computer or a special purpose computer.

The present invention will further be explained below with reference to exemplary embodiments illustrated in the accompanying drawings, in which:

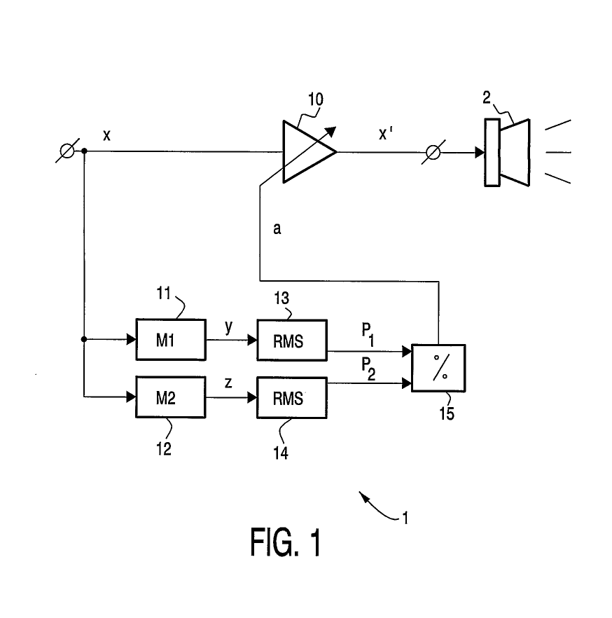

FIG. 1 schematically shows a preferred embodiment of a device according to the present invention.

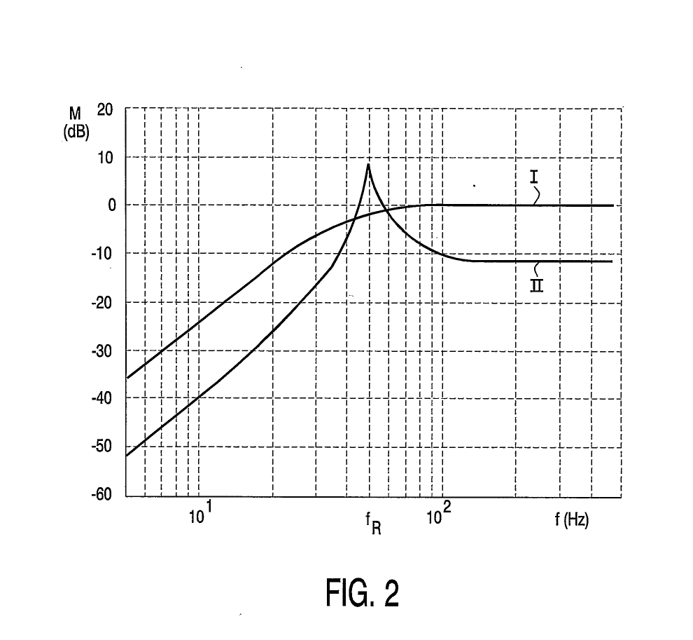

FIG. 2 schematically shows the frequency characteristics of a reference transducer and a resonant transducer.

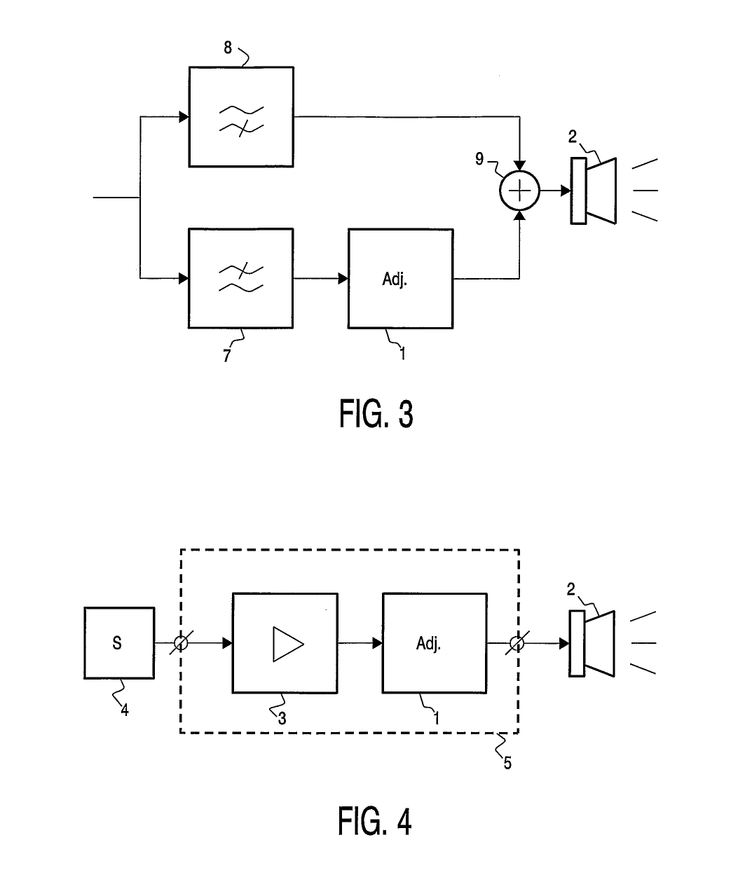

FIG. 3 schematically shows an enhanced embodiment of the device according to the present invention.

FIG. 4 schematically shows an audio system according to the present invention.

The embodiment of the device 1 shown merely by way of non-limiting example in FIG. 1 comprises a first simulation unit 11, a second simulation unit 12, a first signal power determination unit 13, a second signal power determination unit 14, a signal ratio determination unit 15 and a variable amplifier 10. The device 1 is coupled to a transducer 2.

The device 1 receives an (electrical) audio signal x from a suitable source, such as a CD player, a DVD player, an MP3 player, a home cinema system, or a computer.

The audio signal x is fed to both the amplifier 10 and to the first and second simulation units 11 and 12. Each of the simulation units 11, 12 is capable of simulating the response of a transducer (or set of transducers) to the audio signal x. To this end, the simulation units 11, 12 may comprise suitable filters, the respective responses of which correspond with the responses of a reference transducer (not shown) and the actual transducer 2 respectively. Such filters are preferably digital filters, implemented in hardware and/or software. It will be understood that the use of digital filters requires A/D (analog/digital) and D/A (digital/analog) converters which are well known in the art.

The simulation units 11 and 12 can be said to model the behavior of a reference transducer and the actual transducer. The parameters of these models M1 and M2 may be defined by filter parameters. The simulation units comprise a mathematical or hardware model of the transducers and may involve filters that simulate the signal response characteristics of the transducers.

The parameters of the models incorporated in the simulation units 11 and 12 may be determined experimentally, by measuring the sound output of a reference transducer and that of another transducer with are alternatively excited by the same audio signal. The measured output power of the two transducers is used to determine the filter parameters necessary to model the output power in accordance with the invention. This comparison of the output powers is preferably carried out for a signal of substantially a single frequency, or a narrow frequency band.

In response to the audio signal x, the simulation units 11 and 12 produces signals y and z representing the simulated sound outputs of a reference transducer and the actual transducer 2 respectively. These signals y and z are, in the embodiment shown, passed on to signal amplitude determination units 13 and 14 which determine the amplitudes of the signals y and z respectively. In the preferred embodiment shown, the units 13 and 14 determine the RMS (Root Mean Square) value of the respective signals. Those skilled in the art will realize that the RMS value is a suitable measure of the amplitude and energy of a signal, and that other amplitude measurements and energy measurements, such as the absolute value of the signal, may be alternatively used.

Each amplitude (or energy) content determination unit 13, 14 produces an amplitude (or energy) signal P₁, P₂ in response to the signals y and z respectively. The amplitude signals P₁, P₂ are fed to a ratio determination unit 15 that determines the ratio of these signals and thereby of the respective amplitudes (or energy contents) of the signals y and z. In this way, it can be determined whether the sound produced by the transducer 2 would be louder or less loud than when produced by the reference transducer. If the sound would be louder, then the adjustment signal a produced by the ratio unit 15 will decrease the amplification of the controlled amplifier 10, resulting in an audio output signal x′ having a smaller amplitude. If the sound is less loud, then the amplification of the amplifier 10 is increased. This will be explained in more detail with reference to FIG. 2. It is noted that the device of the present invention uses predicted sound outputs, not measured sound outputs, to adjust the amplification.

In FIG. 2, two transducer characteristics I and II are illustrated. These characteristics represent the (magnitude of the) response M as a function of the frequency f. The first curve I indicates the normalized characteristic of a reference transducer, while the second curve II shown the characteristic of a resonant transducer.

As can be seen, the resonant transducer of the second curve II has, in the present example, a peak at a resonance frequency f_{R}=50 Hz. At the resonance frequency f_{R} the efficiency of the resonant transducer is very high, in fact higher than the efficiency of the reference transducer. As a result, an audio signal component of approximately 50 Hz will sound louder when rendered by the resonant transducer (curve II) than when rendered by the regular reference transducer (curve I). Conversely, an audio signal component of approximately 100 Hz will sound less loud when rendered by the resonant transducer (curve II) than when rendered by the regular reference transducer (curve I).

The present invention compensates this difference in (measured of perceived) output sound level by decreasing the sound level at 50 Hz (for this particular transducer) and increasing the output sound level at, for example, 40 and 80 Hz. In this way, the (measured or perceived) sound level output by the resonant transducer is made approximately equal to the sound level that would be produced by a regular transducer, by adjusting the amplification. It is noted that this adjustment may be optimal for a single frequency and will typically be sub-optimal for a frequency band. Still, for relatively narrow frequency bands, an excellent adjustment may be achieved. It is further noted that the present invention does not attempt to alter the characteristic itself but merely adjusts the amplification in accordance with the characteristic.

To obtain a better accuracy, the audio input signal x preferably has a limited frequency band, for example 30-80 Hz in the present example, or even 40-60 Hz. The audio signal x may therefore be the output signal of a band-pass filter having a relatively narrow pass-band centered around, for example, 50 Hz.

It is noted that the audio input signal x and the corresponding audio output signal x′, y, z, P₁ and P₂ are functions of time. The signal x could therefore be written as x=x(t) in case the signal is analog, and x=x(i) in case the signal is digital. However, for the sake of convenience the notation x rather than x(t) is used.

It is further noted that the device 1 of FIG. 1 may comprise a further amplifier (not shown) arranged between the amplifier 10 and the transducer 2. The device may also comprise a pre-amplifier (not shown). In addition, the transducer 2 may be replaced with a set of transducers. Each transducer may be constituted by a loudspeaker, a so-called “shaker”, or any other transducer capable of converting electrical signals into sound.

An enhancement of the device 1 is illustrated in FIG. 3. A first filter 7 and a second filter 8 are arranged in parallel, the first filter 7 being connected in series with the device 1. In the example shown, the first filter 7 is a low-pass filter while the second filter 8 is a high-pass filter, but a reversed arrangement is also possible. A combination unit 9, which is preferably constituted by an adder, combines the output signals of the second filter 8 and the device 1 and feeds the combined output signal to the transducer 2.

The filters 7 and 8 preferably have complementary pass-bands, their cross-over point for example being 100 Hz or 50 Hz. In this way, the device 1 is only operative for the low-frequency part of the audio signal, leaving the high-frequency part unaltered. As the part of the audio signal adjusted by the device 1 has a narrower frequency band, the accuracy of the adjustment is increased.

It will be understood that instead of two filters, a plurality of filters could be used, each having an individual pass-band. A device 1 of the present invention could be arranged in series with at least one but preferably two or more filters to provide amplitude adjustment in the respective frequency band. In this way, a plurality of frequency bands can be individually adjusted.

The exemplary audio system 5 of FIG. 4 comprises a sound processing unit 3 and a device 1 according to the present invention. The sound processing unit 3 may comprise an amplifier and any suitable filters and/or equalizers. The order of the sound processing unit 3 and the device 1 may be reversed.

The audio system 5 receives an audio input signal from an audio source 4 coupled to the input terminal of the system 5. The audio source 4 may be constituted by a CD player, DVD player, MP3 player, radio tuner, computer, internet terminal or a similar sound source. At least one transducer 2 is connected to the output terminal of the audio system 5. This transducer may be a resonant transducer, having a response peak at a particular frequency.

In accordance with the present invention, the device 1 has a frequency-dependent sound level control that takes the characteristics of the transducer 2 into account. It will be understood that several transducers may be connected to the audio system 5, and that typically not all of those transducers have a “peaked” characteristic as shown in FIG. 2. A high-frequency transducer (“tweeter”) may, for example, also be coupled to the audio system 5.

The audio system 5 may be (part of), for example, a home cinema system, a home sound (stereo) system, a car sound system, a television set, or a sound system of a personal computer.

The term computer program product should be understood to comprise any physical realization, e.g. an article of manufacture, of a collection of commands enabling a processor—generic or special purpose—, after a series of loading steps to load the commands in the processor, to execute any of the characteristic functions of an invention. In particular the computer program product may be realized as program code, processor adapted code derived from this program code, or any intermediate translation of this program code, on a carrier such as e.g. a disk or other plug-in component, present in a memory, temporarily present on a network connection—wired or wireless—, or program code on paper. Apart from program code, invention characteristic data required for the program may also be embodied as a computer program product.

The present invention is based upon the insight that transducers having a “peaked” characteristic may reproduce sound of different frequencies at greatly varying sound levels. The present invention benefits from the further insight that this problem may be solved by a frequency-dependent and transducer-dependent amplification of the sound.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A device (1) for adjusting the amplitude of an audio signal (x) in accordance with the characteristics of a transducer (2), the device comprising equivalent output adjustment means (10-15) for adjusting the amplitude of the audio signal (x) such that the output power of the transducer (2) is equivalent to the output power of a reference transducer.

2. The device according to claim 1, wherein the equivalent output adjustment means comprise:
first simulation means (11) for producing, in response to the audio signal (x), a first signal (y) indicative of the output of a reference transducer,
second simulation means (12) for producing, in response to the audio signal (x), a second signal (z) indicative of the output of the actual transducer (2),
comparator means (13, 14, 15) for comparing the first signal (y) and the second signal (z) and for producing an adjustment signal (a), and
adjustment means (10) for adjusting the amplitude of the audio signal (x) in response to the adjustment signal (a).

3. The device according to claim 2, wherein the first simulation means (11) and the second simulation means (12) each contain a model of a respective transducer.

4. The device according to claim 3, wherein the model is defined by parameters of a filter.

5. The device according to claim 4, wherein the parameters are determined experimentally by comparing the sound output of two transducers.

6. The device according to claim 2, wherein the first simulation means (11) and the second simulation means (12) each comprise weighting means for perceptually weighting the audio signal (x).

7. The device according to claim 2, wherein the comparator means comprise first and second signal amplitude determination means (13, 14) for determining the energy of the first signal (y) and the second signal (z) respectively.

8. The device according to claim 7, wherein the comparator means comprise amplitude ratio determination means (15) for determining the ratio of the amplitudes of the first signal (y) and the second signal (z) and for producing the adjustment signal (a) in accordance with said ratio.

9. The device according to claim 2, wherein the adjustment means comprise a controlled amplifier (10).

10. An audio system (5) comprising a device (1) according to claim 1.

11. The audio system according to claim 10, further comprising a first filter unit (7) for filtering the audio signal (x) prior to being fed to the device (1), a second filter unit (8) arranged in parallel to the first filter unit, and a combination unit (9) for combining the output signals of the device (1) and the second filter unit (8).

12. The audio system according to claim 10, which is a home cinema system or a car sound system.

13. A television set comprising an audio system (5) according to claim 10.

14. A method of adjusting the amplitude of an audio signal (x) in accordance with the characteristics of a transducer (2), the method comprising the step of adjusting the amplitude of the audio signal (x) such that the output power of the transducer is equivalent to the output power of a reference transducer.

15. The method according to claim 14, further comprising the steps of:
producing, in response to the audio signal (x), a reference signal (y) indicative of the output of a reference transducer,
producing, in response to the audio signal (x), a further signal (z) indicative of the output of the actual transducer (2),
comparing the reference signal (y) and the further signal (z) and producing an adjustment signal (a), and
adjusting the amplitude of the audio signal (x) in response to the adjustment signal (a).

16. The method according to claim 15, wherein the reference signal (y) and the further signal (z) are determined in accordance with transducer models.

17. The method according to claim 15, wherein the step of comparing involves producing the amplitudes of both the reference signal (y) and the further signal (z), and determining the ratio of these amplitudes to produce the adjustment signal.

18. The method according to claim 15, further comprising the step of perceptually weighting the audio signal (x).

19. The method according to claim 15, further comprising the prior step of filtering the audio signal (x).

20. A computer program product for carrying out the method according to claim 14.
